(19) United States
(12) Patent Application Publication
(10) Pub. No.: US 2005/0190154 A1
(43) Pub. Date: Sep. 1, 2005

(54) Mouse for portable device

(76) Inventor: Chin-Chang Kuo, Taipei Hsien (TW)

Correspondence Address: TROXELL LAW OFFICE PLLC, SUITE 1404, 5205 LEESBURG PIKE, FALLS CHURCH, VA, 22041, US

(21) Appl. No.: 10/787,198

(22) Filed: Feb. 27, 2004

(51) Int. Cl. G09G 5/08

(52) U.S. Cl. 345/163

(57) ABSTRACT

A mouse for portable device comprising a base with a corresponding top shell, a circuit board with electrical circuitry is inside the base, the circuit board connects to a connector base, the connector base connects to portable electrical devices; a frame is on the front of the base to hold a wheel, the wheel passes through the circuit board and exposes on a wheel hole of the top shell for users to roll; a speaker is inside the base to broadcast voices, the speaker is fixed onto a depression of the base, several speaker holes are on the depression; a concave slot is on the front of the base, a microphone to receive voices is inside the concave slot, the microphone is electrically connected to the speaker, the microphone also connects to a plug-in connector hole, the plug-in connector hole can connect to the microphone plug of a portable electrical device through a connector; the portable device can receive and broadcast voices through the mouse for space saving and convenient to carry purpose.

### BACKGROUND OF THE INVENTION

I. Field of the Invention

This invention relates generally to a mouse for portable device and, more specifically, to a mouse for portable device that combines microphone and speaker together, the portable device can receive and broadcast voices through the mouse for space saving and convenient to carry.

II. Description of the Prior Art

Heretofore, it is known that the design trend of current laptop computers is lighter, smaller and thinner; due to the limitation of internal space, only the necessary parts are installed inside, some secondary accessories are sacrificed, for example, speakers that broadcast voices and speaker that receives voices. If those secondary accessories are installed, the physical size will be increased.

Current laptop computers have touch-pad and joystick to replace mouse, however most of people still prefer mouse as pointing device. Current mouse either are mechanical or optical with different outlook, the mouse is still a pointing device to control the computers without other functions.

### SUMMARY OF THE INVENTION

It is therefore a primary object of the invention to provide a mouse for portable device that combine the microphone and speaker with a mouse, the portable device can receive and broadcast voices through the mouse for space saving and convenient to carry purpose.

In order to achieve the objective set forth, a mouse for portable device in accordance with the present invention comprises a base with a corresponding top shell, a circuit board with electrical circuitry is inside the base, the circuit board connects to a connector base, and the connector base connects to portable electrical devices. A frame is on the front of the base to hold a wheel, the wheel passes through the circuit board and exposes on a wheel hole of the top shell for users to roll; a speaker is inside the base to broadcast voices, the speaker is fixed onto a depression of the base, several speaker holes are on the depression; a concave slot is on the front of the base, a microphone to receive voices is inside the concave slot, the microphone is electrically connected to the speaker, the microphone also connects to a plug-in connector hole, the plug-in connector hole can connect to the microphone plug of a portable electrical device through a connector.

### BRIEF DESCRIPTION OF THE DRAWINGS

The accomplishment of the above-mentioned object of the present invention will become apparent from the following description and its accompanying drawings which disclose illustrative an embodiment of the present invention, and are as follows:

FIG. 1 is a perspective view of the present invention;

FIG. 2 is an assembly view of the present invention;

FIG. 3 is an application view of the present invention;

FIG. 4 is another application view of the present invention.

### DESCRIPTION OF THE PREFERRED EMBODIMENT

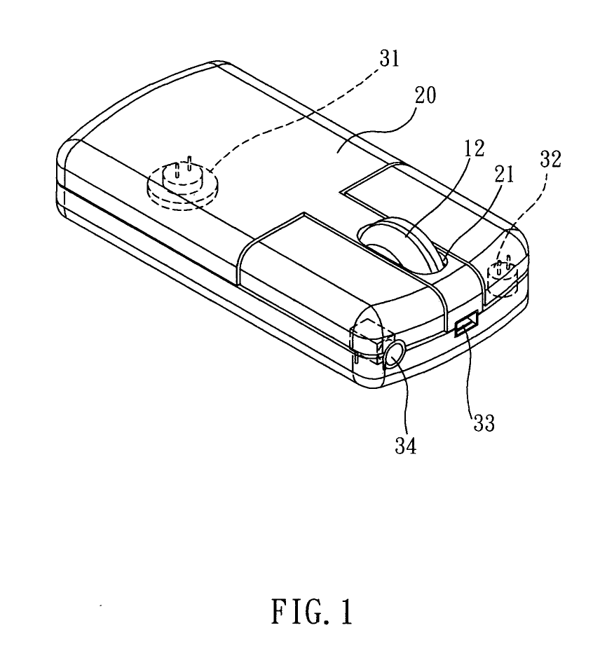

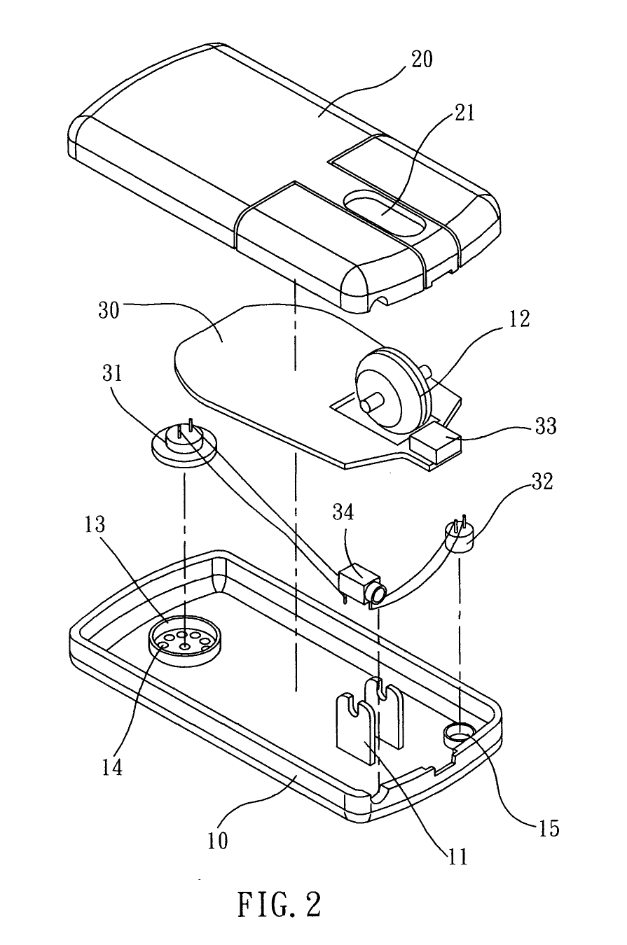

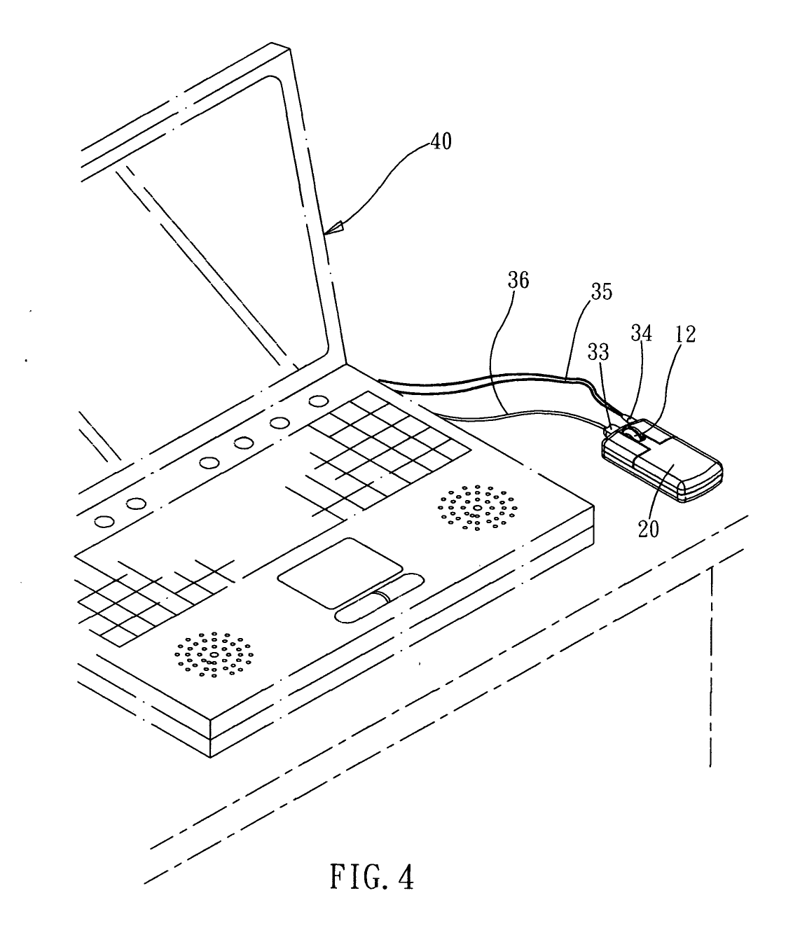

Referring to FIG. 1 and FIG. 2, the present invention is a computer mouse, a mouse applied for the portable computers, comprises a base 10 with a corresponding top shell 20, a circuit board 30 with electrical circuitry is inside the base 10, the electrical circuitry is a basic mouse circuitry; the circuit board 30 connects to a connector base 33, the connector base 33 can connect to portable electrical devices (as shown in FIG. 4); the connector base 33 is a USB (Universal Series Bus) connector in this application (the connector base 33 can be other types in different application).

A frame II is on the front of the base 10 to hold a wheel 12, the wheel 12 passes through the circuit board 30 and exposes on a wheel hole 21 of the top shell 20 for users to roll, a speaker 31 is inside the base 10 to broadcast voices, the speaker 31 is fixed onto a depression 13 of the base 10, several speaker holes 14 are on the depression 13.

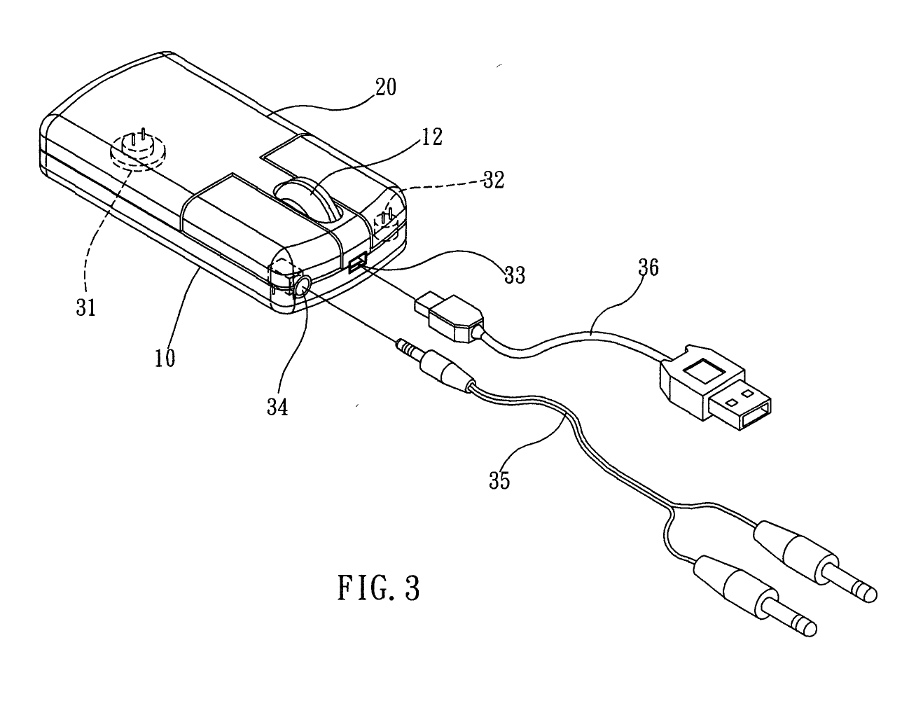

A concave slot 15 is on the front of the base 10, a microphone 32 to receive voices is inside the concave slot 15, the microphone 32 is electrically connected to the speaker 31, the microphone 32 also connects to a plug-in connector hole 34, the plug-in connector hole 34 can connect to the microphone plug of a portable electrical device through a connector 35 (as shown in FIG. 3 and FIG. 4).

In application, referring to FIG. 3 and FIG. 4, users can have a converter 36 (an USB converter in this application) connect to the connector base 33 of the mouse and the connector of the portable device 40, a lap-top computer in this application; the present invention connects to the portable device 40 through the converter 36, users can move the cursor and operate programs on the portable device 40, the connector 35 is connected to the plug-in connector hole 34, the other end is plugged onto the microphone jacket of the portable device 40, the portable device 40 can broadcast and receive voices through the speaker 31 and the microphone 32, such mechanism can not only save the carrying space but also combine different electronic devices.

While a preferred embodiment of the invention has been shown and described in detail, it will be readily understood and appreciated that numerous omissions, changes and additions may be made without departing from the spirit and scope of the invention.

1. An mouse for portable device comprising:
a base;
a top shell covers said base;
a circuit board with electrical circuitry is installed between said base and said top shell, said circuit board connects to a connector base, said connector base connects to portable electrical devices;
a speaker is inside said base, a microphone is electrically connected to said speaker, said microphone connects to a plug-in connector hole, said plug-in connector hole connects to the microphone plug of a portable electrical device, the portable device receives voices and broadcast voices through said microphone and said speaker.

2. The mouse for portable device recited in claim 1, wherein said connector base connects to a portable electrical device through a connector.

3. The mouse for portable device recited in claim 1, wherein said plug-in connector hole connects to a portable device through a converter.

4. The mouse for portable device recited in claim 1, wherein said connector base is a USB connector.

5. The mouse for portable device recited in claim 1, wherein said speaker is fixed onto a depression of said base, several speaker holes are on said depression.

6. The mouse for portable device recited in claim 1, wherein a concave slot is on the front of said base, said microphone is inside said concave slot.
